(19) United States
(12) Patent Application Publication
(10) Pub. No.: US 2025/0205807 A1
(43) Pub. Date: Jun. 26, 2025

(54) WELDING APPARATUS AND WELDING METHOD FOR ULTRA-NARROW WELDING GAP

(71) Applicants: CHINA CONSTRUCTION SCIENCE AND INDUSTRY CORPORATION LTD., Shenzhen (CN); NRG INTELLIGENT WELDING EQUIPMENT CO., LTD., Wuhan (CN)

(72) Inventors: Ying WEI, Shenzhen (CN); Renge LI, Shenzhen (CN); Fuju ZHANG, Shenzhen (CN); Yongqiang QIAO, Shenzhen (CN); Yongwei LI, Shenzhen (CN); Qingnian WEN, Shenzhen (CN)

(73) Assignees: CHINA CONSTRUCTION SCIENCE AND INDUSTRY CORPORATION LTD., Shenzhen (CN); NRG INTELLIGENT WELDING EQUIPMENT CO., LTD., Wuhan (CN)

(21) Appl. No.: 18/762,376

(22) Filed: Jul. 2, 2024

(30) Foreign Application Priority Data
Dec. 26, 2023 (CN) 202311816551.0

(51) Int. Cl. B23K 9/32; B23K 9/16; B23K 35/38; B23K 37/00

(52) U.S. Cl. CPC B23K 9/325; B23K 9/164; B23K 35/38; B23K 37/003

(57) ABSTRACT

The present invention provides a welding apparatus and a welding method for ultra-narrow welding gap, relating to the technical field of welding with an ultra-narrow welding gap. The welding apparatus for ultra-narrow welding gap comprises: a blowing mechanism, a conductive nozzle and an industrial water-cooling unit. The industrial water-cooling unit is connected to the blowing mechanism. A medium flow of the industrial water-cooling unit flows through the inside of the blowing mechanism. The industrial water-cooling unit is configured to reduce a temperature of the shielding gas outputted by the blowing mechanism and a temperature of the conductive nozzle.

### TECHNICAL FIELD

The present invention relates to the technical field of welding with an ultra-narrow welding gap, and specifically relates to a welding apparatus and a welding method for ultra-narrow welding gap.

### BACKGROUND

Since the arc welding technique began to be applied in the field of industrial manufacturing on a large scale in the 1920s, welding gaps need to be opened in the structural welding of medium-thick plates, thick plates, large thick plates and ultra-thick plates, and the arc needs to be controlled to be located inside the welding gap for fillet welding.

In order to further reduce the amount of welding work, welding technology with an ultra-narrow welding gap is adopted. Due to the small size of the welding gap, the two sidewalls of the welding gap necessarily become one of the electrodes for gas-conducting arc, the distance of the welding wire as the other electrode for the arc (the exposed section of welding wire that extends from the conductive nozzle) from the bottom of the welding gap is greater than the distance of the welding wire from the two sidewalls, so that a burning occurs between the welding wire and one of the two sidewalls of the gap, which forms an arc bypassing. The arc bypassing would cause the bottom of the welding gap to be unwelded, resulting in an unfused welded joint with a weld at the top and a large void at the bottom, which will not be able to withstand the working load of the welded joint and is a scrap welded structure.

In the prior art, the only existing technique for controlling the arc to burn at the root of the welding gap without arc bypassing is seen in the physical insulation method. For example: CN201110048535.2 (welding device and welding method for ultra-narrow welding gap using a U-shaped welding flux strip to constrain arc), its principle for elimination of arc bypassing and upward climb is using a non-conductive welding flux strip to form a physical insulation in the area closely adjacent to the gap for insulation between the exposed section of welding wire that extends from the conductive nozzle and the welding gap with two sidewalls in very close proximity, so as to force the gas discharge (arc burning) between the end of the welding wire and the molten pool to sink to the bottom of the welding gap.

However, the physical insulation leads to the complexity of the arc welding process. Because it needs specialized production of auxiliary materials for melt flux strip; and the melting of the melt flux strip would produce a slag that tightly covers the surface of the weld, which is difficult to remove from the bottom of the ultra-narrow welding gap; and a welding flux strip conveying mechanism also needs to be added, which increases the complexity of the processing equipment.

### SUMMARY OF THE INVENTION

Therefore, a technical problem to be solved by the present invention is how to overcome the defects of easily generating a bypass arc in the prior art, so as to provide a welding apparatus for ultra-narrow welding gap.

The present invention provides a welding apparatus for ultra-narrow welding gap that comprises:
a blowing mechanism, configured to output shielding gas;
a conductive nozzle, passing through the blowing mechanism; wherein the conductive nozzle is provided to extend in a gas flow direction; the conductive nozzle is provided with a welding wire at an end thereof in the gas flow direction; the conductive nozzle is configured to provide a welding current and a welding voltage for the welding wire;
an industrial water-cooling unit, connected to the blowing mechanism, wherein a medium flow of the industrial water-cooling unit flows through the inside of the blowing mechanism, the industrial water-cooling unit is configured to reduce a temperature of the shielding gas outputted by the blowing mechanism and a temperature of the conductive nozzle.

As a preferred solution, the welding apparatus for ultra-narrow welding gap comprises:
a mouth structure, being in communication with the blowing mechanism, wherein the mouth structure is sleeved around the periphery of a portion of the conductive nozzle that protrudes out of the blowing mechanism, a circulation channel is formed between the mouth structure and the conductive nozzle.

As a preferred solution, the welding apparatus for ultra-narrow welding gap further comprises:
a power supply, connected to the blowing mechanism.

As a preferred solution, the mouth structure is made of ceramic material.

As a preferred solution, the industrial water-cooling unit is refrigeration equipment with a compressor.

The present invention provides a welding method for ultra-narrow welding gap using the aforementioned welding apparatus for ultra-narrow welding gap, comprising the steps of:
determining a welding gap to be an ultra-narrow welding gap based on a size of the welding gap, and then determining a diameter of a welding wire to be provided at an end of the conductive nozzle based on a size of the welding gap, wherein the diameter of the welding wire is positively correlated with the size of the welding gap;
adjusting an amplitude of welding current on the welding wire by means of the conductive nozzle, so as to control a range of the welding current in such a way as to put the welding wire within a spray transfer range;
adjusting an amplitude welding voltage when the welding wire is within the spray transfer range, such that a range of the amplitude of welding voltage is within a short-circuit transfer range;
continuously outputting shielding gas by the blowing mechanism towards the inside of the welding gap, and continuously reducing a temperature of the shielding gas outputted by the blowing mechanism by means of the industrial water-cooling unit;
feeding the welding wire into the welding gap for welding.

As a preferred solution, the industrial water-cooling unit controls the temperature of the shielding gas at 10° C.-20° C.

As a preferred solution, the shielding gas is a mixture of argon and carbon dioxide.

As a preferred solution, the shielding gas is a mixture of 80% argon and 20% carbon dioxide.

As a preferred solution, when a plate thickness of a weldment exceeds a length of the welding wire, a mouth structure is mounted around the periphery of a portion of the conductive nozzle that protrudes out of the blowing mechanism in a gas flow direction.

The technical solution of the present invention has the following advantages:

1. The welding apparatus for ultra-narrow welding gap provided by the present invention comprises a blowing mechanism, a conductive nozzle and an industrial water-cooling unit. It is able to continuously reduce a temperature of the shielding gas outputted by the blowing mechanism and a temperature of the conductive nozzle by using the industrial water-cooling unit, so that the temperature of the shielding gas and the temperature of the conductive nozzle can be maintained in a low-temperature state all the time. The low-temperature state inhibits ionization of the shielding gas, and thus inhibiting generation of bypass arc. The present technical solution does not require a delivery device that utilizes other welding consumables or auxiliary welding consumables, which makes the welding apparatus more compact, and does not require to deal with welding slag produced by auxiliary welding consumables, which significantly saves the welding time.

2. The welding apparatus for ultra-narrow welding gap provided by the present invention is provided with a mouth structure. When the welding gap is too deep, the mouth structure provided around the periphery of the conductive nozzle and made of ceramic material can effectively prevent the generation of bypass arc between the conductive nozzle and the welding gap.

3. The welding apparatus for ultra-narrow welding gap provided by the present invention, wherein the industrial water-cooling unit is refrigeration equipment with a compressor. The refrigeration equipment with a compressor has the advantages of simple structure and small size, and can realize a larger refrigeration capacity with lower power consumption, thus reducing the cost of use.

4. The welding method for ultra-narrow welding gap provided by the present invention comprises the steps of: determining a welding gap to be an ultra-narrow welding gap based on a size of the welding gap, and then determining a diameter of a welding wire to be provided at an end of the conductive nozzle based on a size of the welding gap, wherein the diameter of the welding wire is positively correlated with the size of the welding gap; adjusting an amplitude of welding current on the welding wire by means of the conductive nozzle, so as to control a range of the welding current in such a way as to put the welding wire within a spray transfer range; adjusting an amplitude of welding voltage when the welding wire is within the spray transfer range, such that a range of the amplitude of welding voltage is within a short-circuit transfer range; continuously outputting shielding gas by the blowing mechanism towards the inside of the welding gap, and continuously reducing a temperature of the shielding gas outputted by the blowing mechanism by means of the industrial water-cooling unit; feeding the welding wire into the welding gap for welding. The present technical solution is able to continuously reduce a temperature of the shielding gas outputted by the blowing mechanism and a temperature of the conductive nozzle by using the industrial water-cooling unit, so that the temperature of the shielding gas and the temperature of the conductive nozzle can be maintained in a low-temperature state all the time, the low-temperature state inhibits ionization of the shielding gas, and by also controlling an amplitude of welding current as well as an amplitude of welding voltage, generation of bypass arc is inhibited.

### BRIEF DESCRIPTION OF THE DRAWINGS

In order to more clearly explain the technical solutions in specific implementations of the present invention or in the prior art, accompanying drawings that need to be used in the description of the specific implementations or the prior art are briefly introduced below. Apparently, the accompanying drawings described below only represent some implementations of the present invention. For a person with ordinary skill in the art, other accompanying drawings are obtainable according to these accompanying drawings without expenditure of any creative labor.

FIG. 1 is an overall structural schematic diagram of the welding apparatus for ultra-narrow welding gap provided by the present invention.

FIG. 2 is a structural schematic diagram of the nozzle-less structure of the welding apparatus for ultra-narrow welding gap provided by the present invention.

FIG. 3 is a structural schematic diagram of the welding gap in the welding apparatus for ultra-narrow welding gap provided by the present invention.

### REFERENCE SIGNS

1, blowing mechanism; 2, conductive nozzle; 3, industrial water-cooling unit; 4, mouth structure; 5, power supply; 6, first weldment; 7, welding wire; 8, molten pool; 9, shielding gas; 10, second weldment.

### DETAILED DESCRIPTION

Hereinafter, the technical solution of the present invention will be clearly and completely described in combination with accompanying drawings. Apparently, the described embodiments only represent part of the embodiments of the present invention, not all the embodiments. All other embodiments obtainable by a person with ordinary skill in the art based on the embodiments described in the present invention without expenditure of creative labor all fall within the scope of protection of the present invention.

In the description of the present invention, it should be noted that, an orientation or positional relationship indicated by terms “center”, “up”, “down”, “left”, “right”, “vertical”, “horizontal”, “inside”, “outside”, etc. is based on an orientation or positional relationship shown based on the accompanying drawings and is only for the purpose of facilitating the description of the present invention and simplifying the description, rather than indicating or implying that an apparatus or element referred to must have a particular orientation or must be constructed and operated in a particular orientation, so that it is not to be construed as a limitation to the present invention.

In the description of the present invention, it should be noted that, unless otherwise expressly defined and limited, the terms “mount”, “couple”, “connect” should be understood in a broad sense, for example, it may be a fixed connection, a detachable connection, or a connection in one piece; it may be a mechanical connection or an electrical connection; it may be a direct connection or an indirect connection through an intermediate medium, or an internal communication of two elements. For a person with ordinary skill in the art, the specific meaning of the above terms in the present invention can be understood according to specific circumstances.

In addition, technical features involved in different embodiments of the present invention described below may be combined with each other as long as they do not conflict with each other.

### Embodiment 1

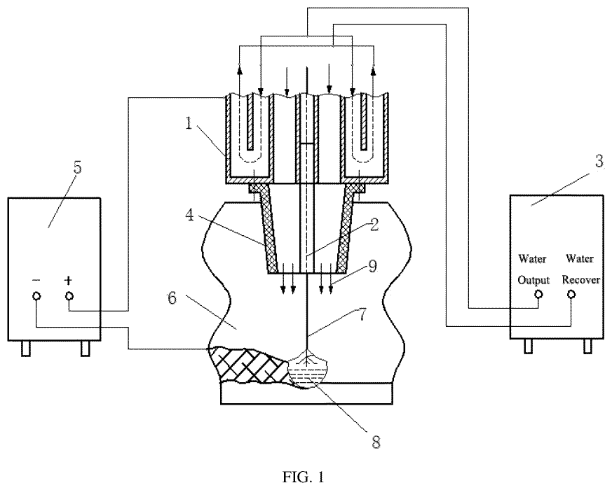

As shown in FIG. 1, the welding apparatus for ultra-narrow welding gap provided by the present invention comprises a blowing mechanism 1, a conductive nozzle 2 and an industrial water-cooling unit 3, wherein the blowing mechanism 1 is configured to blow out shielding gas 9. The conductive nozzle 2 passes through the blowing mechanism 1. The conductive nozzle 2 is provided with a welding wire 7 at an end thereof in the gas flow direction. The conductive nozzle 2 is configured to provide a welding current and a welding voltage for the welding wire 7. The industrial water-cooling unit 3 is connected to the blowing mechanism 1, wherein a medium flow of the industrial water-cooling unit 3 flows through the inside of the blowing mechanism 1, the industrial water-cooling unit 3 is configured to reduce a temperature of the shielding gas 9 outputted by the blowing mechanism 1 and a temperature of the conductive nozzle 2. It is able to continuously reduce a temperature of the shielding gas 9 outputted by the blowing mechanism 1 and a temperature of the conductive nozzle 2 by using the industrial water-cooling unit 3, so that the temperature of the shielding gas 9 and the temperature of the conductive nozzle 2 can be maintained in a low-temperature state all the time. The low-temperature state inhibits ionization of the shielding gas 9, and thus inhibiting generation of bypass arc. The present technical solution does not require a delivery device that utilizes other welding consumables or auxiliary welding consumables, which makes the welding apparatus more compact, and does not require to deal with welding slag produced by auxiliary welding consumables, which significantly saves the welding time.

It should be noted that, the industrial water-cooling unit 3 may use refrigeration equipment with a compressor. The refrigeration equipment with a compressor has the advantages of simple structure and small size, and can realize a larger refrigeration capacity with lower power consumption, thus reducing the cost of use. Wherein the industrial water-cooling unit 3 is specifically provided with a compressor, a power pump, pipelines and other structures. The pipelines are configured to be provided inside the blowing mechanism 1, through which a heat exchanger medium is provided. The heat exchanger medium is made to flow inside the heat exchanger pipelines by means of the power pump, and the cooling energy produced by the compressor is transferred to the blowing mechanism 1 through the heat exchanger medium. The shielding gas 9 exchanges heat with the blowing mechanism 1 when flowing through it, so as to realize the cooling effect of the industrial water-cooling unit 3 on the shielding gas 9.

Further, when a plate thickness of a weldment is large, it is also needed to provide a mouth structure 4, being in communication with the blowing mechanism 1, wherein the mouth structure 4 is sleeved around the periphery of a portion of the conductive nozzle 2 that protrudes out of the blowing mechanism 1, a circulation channel is formed between the mouth structure 4 and the conductive nozzle 2. The mouth structure 4 can prevents arcing between the conductive nozzle 2 and the two sidewalls of the welding gap. The shielding gas 9 reaches the attached welding wire 7 after passing through the circulation channel, thereby realizing the protection for the welding wire 7. In this embodiment, the mouth structure 4 is in the shape of a circular frustum, and is gradually tapered along the flow direction of the shielding gas 9. The area of opening at one end of the mouth structure 4 is larger than the area of opening at the other end thereof. The shielding gas 9 enters into the end of the mouth structure 4 with the larger opening and flows out from the end thereof with the smaller opening, so that the mouth structure 4 is designed to have a converging effect on the shielding gas 9 so as to increase the effective protective range of the shielding gas 9.

It should be noted that the mouth structure 4 is normally required when a plate thickness of a weldment is larger than 16 mm.

It should be noted that the mouth structure 4 is made of ceramic material in this embodiment, and as an alternative embodiment, insulating materials such as plastic, rubber, etc. may also be used.

Further, the welding apparatus for ultra-narrow welding gap further comprises: a power supply 5, connected to the blowing mechanism 1. The power supply 5 can supply energy to the blowing mechanism 1, the conductive nozzle 2 and the industrial water-cooling unit 3. The power supply 5 is generally provided on one side of the blowing mechanism 1.

### Embodiment 2

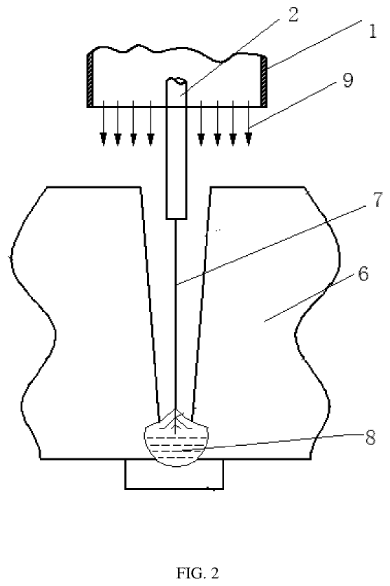

As shown in FIG. 2, the welding method for ultra-narrow welding gap provided by the present invention, using the welding apparatus of Embodiment 1, comprises the steps of: determining a welding gap to be an ultra-narrow welding gap based on a size of the welding gap, and then determining a diameter of a welding wire 7 to be provided at an end of the conductive nozzle 2 based on a size of the welding gap, wherein the diameter of the welding wire 7 is positively correlated with the size of the welding gap; adjusting an amplitude of welding current on the welding wire 7 by means of the conductive nozzle 2, so as to control a range of the welding current in such a way as to put the welding wire 7 within a spray transfer range; adjusting an amplitude of welding voltage when the welding wire 7 is within the spray transfer range, such that a range of the amplitude of welding voltage is within a short-circuit transfer range; continuously outputting shielding gas 9 by the blowing mechanism 1 towards the inside of the welding gap, and continuously reducing a temperature of the shielding gas 9 outputted by the blowing mechanism 1 by means of the industrial water-cooling unit 3; feeding the welding wire 7 into the welding gap for welding. The present technical solution is able to continuously reduce a temperature of the shielding gas 9 outputted by the blowing mechanism 1 and a temperature of the conductive nozzle 2 using the industrial water-cooling unit 3, so that the temperature of the shielding gas 9 and the temperature of the conductive nozzle 2 can be maintained in a low-temperature state all the time, the low-temperature state inhibits ionization of the shielding gas 9, and by also controlling an amplitude of welding current as well as an amplitude of welding voltage, generation of bypass arc is inhibited.

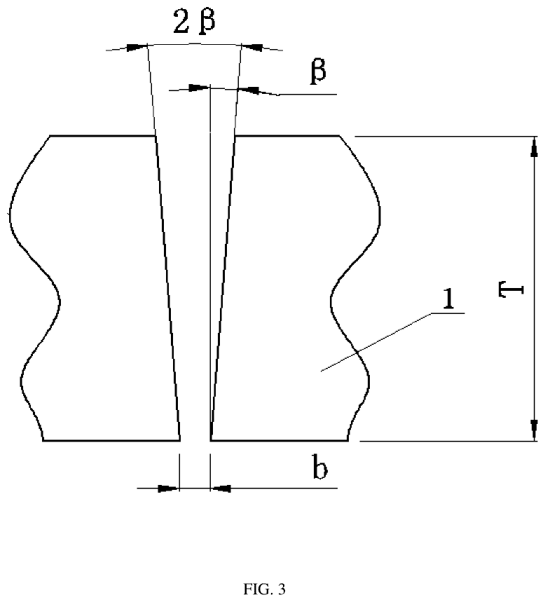

As shown in FIG. 3, it should be noted that the ultra-narrow welding gap is designed to have a very small gap face angle. The ultra-narrow welding gap with a very small gap face angle means that, the minimum assembly gap at the root thereof is in the category of ultra-narrow welding gap, wherein the gap faces of the two sidewalls are not in a perpendicular state (0°), but are in an inclined state with a very small gap face angle. The size of gap face angle varies inversely proportional to a plate thickness of a weldment, i.e., when the plate thickness is small, the gap face angle is large, and when the plate thickness is large, the gap face angle is small. The range of the very small gap face angle is 0.5°-4°. The maximum value of the size of minimum assembly gap at the root is 6 mm.

In this embodiment, the gap face angle is β, the size of minimum assembly gap at the root is b, the plate thickness of the weldment is T, the size of the gap face angle β varies inversely proportional to the plate thickness of the weldment T, i.e., when the plate thickness of the weldment T is small, the gap face angle β is large, and when the plate thickness of the weldment T is large, the gap face angle β is small. The range of the sum 2β of the very small gap face angle pair is 2°-4°. The gap face angle β of each of the first weldment and the second weldment is 0.5°-3°. In the present example, the plate thickness of the weldment T is 300 mm, β is 0.5°, and the size b of minimum assembly gap at the root is 5 mm.

In this embodiment, the mouth structure 4 is required since the plate thickness is larger than 16 mm. The mouth structure 4 realizes insulation between the weldment and the conductive nozzle 2.

It should be noted that the welding wire 7 is burned and fused at the bottom of the welding gap, and this area becomes the molten pool 8.

It should be noted that the welding wire 7 is selected to be a solid-core welding wire 7 in this embodiment, the diameter of the welding wire 7 ranges from 0.8 mm to 1.2 mm. Specifically, the diameter of the welding wire 7 is selected to be 1.2 mm in the present example.

It should be noted that, under a given diameter of the welding wire 7, as one of the important parameters of the arc energy characteristics, the welding current is selected to be in the range of medium to medium-low that corresponds to the spray transfer standard zone for the welding wire 7. The welding current ranges from 220 A to 270 A when the diameter of the welding wire 7 is 1.2 mm.

It is also necessary to control the length of the arc (referred to as arc length), that is, by controlling the welding voltage. The welding voltage is controlled to be in the medium or medium-high zone of the arc voltage range that matches the corresponding current within the spray transfer range, so as to prevent the arc diffusion angle from being too large, that is, to prevent the diameter of the cathode conductive zone from being too large. The range of the welding voltage is 23V-28V when the range of the welding current is 220 A-270 A.

It is also necessary to control the arc stiffness (rigidity), the arc stiffness is positively correlated with the arc force, as the most important component factor of the arc force: both the electromagnetic contraction force and the plasma flow force are positively correlated with the current intensity, so the arc stiffness is adjusted to medium-high level, in order to increase the radial compression effect of the magnetic field on the arc to prevent its radial expansion. The type and the flow rate of the shielding gas also to a certain extent affects the arc stiffness, in the present invention, the use of a very low flow rate of primary shielding gas and the selection of polyatomic gas having relatively low dissociation energy (such as CO₂ at a certain percentage) is advantageous for preventing arc bypassing. The shielding gas 9 is a mixture of argon and carbon dioxide.

It should be noted that, in the present example, the flow rate of the shielding gas 9 is 8 L/min˜10 L/min, and the shielding gas 9 is specifically a mixture of 80% argon and 20% carbon dioxide.

It should be noted that the bypass arc all occurs over the section of the welding wire 7 that extends out from the conductive nozzle 2, and controlling a preheating temperature of this section of the welding wire 7 at a very low temperature would be advantageous for inhibiting ionization of the shielding gas 9 surrounding the welding wire 7, thereby inhibiting generation of bypass arc.

It should be noted that, in this embodiment, not only is it needed to use the industrial water-cooling unit 3 to provide cooling circulation water with a very low and constant temperature, and to use this low-temperature circulation water to efficiently cool the conductive nozzle 2 and the welding wire guide tube in the body of the welding gun, so that the conductive nozzle 2 and the welding wire guide tube at the rear end thereof are always at a very low temperature level, but it is also needed to control the position of the access point for inputting current into the welding wire 7 serving as an electrode, in such a way that the energizing path that flows through the welding wire 7 is as short as possible. In this embodiment, the industrial water-cooling unit 3 controls the temperature of the shielding gas 9 to be at 10° C.-20° C. The anode current flows through the welding wire 7 over a distance of only about 20 mm.

### Embodiment 3

This embodiment is another basic embodiment as an alternative of Embodiment 2. In this embodiment, the plate thickness of the weldment T is 20 mm, the sum 2β of the very small gap face angle pair is 4°, the gap face angle β of each of the first weldment and the second weldment is 2°, and the size b of minimum assembly gap at the root is 4.5 mm. The diameter of the welding wire 7 in this embodiment is 1.0 mm.

The remaining parameters and steps are the same as in Embodiment 2.

Apparently, the above embodiments are only examples for clear illustration and are not a limitation to the implementation ways. For a person with ordinary skill in the art, other changes or variations in different forms may be made on the basis of the above description. It is unnecessary and impossible to be exhaustive for all implementation ways herein. Any obvious changes or variations derived therefrom still fall within the scope of protection of the present invention.

1. A welding apparatus for ultra-narrow welding gap, comprising:
a blowing mechanism (1), configured to output shielding gas (9);
a conductive nozzle (2), passing through the blowing mechanism (1); wherein the conductive nozzle (2) is provided to extend in a gas flow direction; the conductive nozzle (2) is provided with a welding wire (7) at an end thereof in the gas flow direction; the conductive nozzle (2) is configured to provide a welding current and a welding voltage for the welding wire (7);
an industrial water-cooling unit (3), connected to the blowing mechanism (1), wherein a medium flow of the industrial water-cooling unit (3) flows through the inside of the blowing mechanism (1), the industrial water-cooling unit (3) is configured to reduce a temperature of the shielding gas (9) outputted by the blowing mechanism (1) and a temperature of the conductive nozzle (2).

2. The welding apparatus for ultra-narrow welding gap according to claim 1, wherein the welding apparatus for ultra-narrow welding gap comprises:
a mouth structure (4), being in communication with the blowing mechanism (1), wherein the mouth structure (4) is sleeved around the periphery of a portion of the conductive nozzle (2) that protrudes out of the blowing mechanism (1), a circulation channel is formed between the mouth structure (4) and the conductive nozzle (2).

3. The welding apparatus for ultra-narrow welding gap according to claim 1, wherein the welding apparatus for ultra-narrow welding gap further comprises:
a power supply (5), connected to the blowing mechanism (1).

4. The welding apparatus for ultra-narrow welding gap according to claim 2, wherein the mouth structure (4) is made of ceramic material.

5. The welding apparatus for ultra-narrow welding gap according to claim 1, wherein the industrial water-cooling unit (3) is refrigeration equipment with a compressor.

6. A welding method for ultra-narrow welding gap using the welding apparatus for ultra-narrow gaps according to claim 1, comprising the steps of:
determining a welding gap to be an ultra-narrow welding gap based on a size of the welding gap, and then determining a diameter of a welding wire (7) to be provided at an end of the conductive nozzle (2) based on a size of the welding gap, wherein the diameter of the welding wire (7) is positively correlated with the size of the welding gap;
adjusting an amplitude of welding current on the welding wire (7) by means of the conductive nozzle (2), so as to control a range of the welding current in such a way as to put the welding wire (7) within a spray transfer range;
adjusting an amplitude of welding voltage when the welding wire (7) is within the spray transfer range, such that a range of the amplitude of welding voltage is within a short-circuit transfer range;
continuously outputting shielding gas (9) by the blowing mechanism (1) towards the inside of the welding gap, and continuously reducing a temperature of the shielding gas (9) outputted by the blowing mechanism (1) by means of the industrial water-cooling unit (3);
feeding the welding wire (7) into the welding gap for welding.

7. The welding method for ultra-narrow welding gap according to claim 6, wherein the industrial water-cooling unit (3) controls the temperature of the shielding gas (9) at 10° C.-20° C.

8. The welding method for ultra-narrow welding gap according to claim 6, wherein the shielding gas (9) is a mixture of argon and carbon dioxide.

9. The welding method for ultra-narrow welding gap according to claim 6, wherein the shielding gas (9) is a mixture of 80% argon and 20% carbon dioxide.

10. The welding method for ultra-narrow welding gap according to claim 6, wherein
when a plate thickness of a weldment exceeds a length of the welding wire (7), a mouth structure (4) is mounted around the periphery of a portion of the conductive nozzle (2) that protrudes out of the blowing mechanism (1) in the gas flow direction.
